(19) United States
(12) Patent Application Publication
(10) Pub. No.: US 2004/0130566 A1
(43) Pub. Date: Jul. 8, 2004

(54) Method for producing computerized multi-media presentation

(76) Inventors: Prashant Banerjee, Westmont, IL (US); Sanjay Mehrotra, Winnetka, IL (US); Craig Barnes, Forest Park, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/457,007

(22) Filed: Jun. 6, 2003

Related U.S. Application Data
(60) Provisional application No. 60/438,713, filed on Jan. 7, 2003.

(51) Int. Cl. G09G 5/00

(52) U.S. Cl. 345/716

(57) ABSTRACT

A method and system is described for the generation of meta-slides which can be used for 3D presentations and documentation. Meta-slides represent an organizing principle suitable for 3D virtual reality and multimedia (i.e. video, audio, text and images) content creation. Multiple avatars, actors, objects, text and slides are assembled in a meta-slide performing actions synchronously or asynchronously. The meta-slides and scenes are edited on a time line. The user can interact and dynamically update the content of the presentation during the content playback in the playback window. The playback window and meta-slides can become part of an internet browser or remain standalone.

### RELATED APPLICATIONS

This application is based upon, and claims priority to, previously filed provisional application serial No. 60/438,713, filed on Jan. 7, 2003. The provisional application is hereby incorporated by reference.

### GOVERNMENTAL RIGHTS

The United States Government retains certain rights in this invention. Financial support was provided at least in part by the Department of Commerce under NIST ATP Cooperative Agreement No. 70NANB1H3014.

### FIELD OF THE INVENTION

This invention relates to systems and methods for the presentation of multi-media content including slide-sequences, video animation, and audio.

### BACKGROUND

Existing presentation technologies operate with static digital multimedia slides which operate in a 2D environment. A popular example is Microsoft Powerpoint which allows playing of the static slides through a slide show. Other examples of such presentation technologies are found in U.S. Pat. Nos. 5,917,480, 6,396,500, 6,008,807, and U.S. patent application No. 20020099549. The plurality of slides in these systems refers only to linear sequencing (e.g. forwarding and rewinding) of slides. The actions of agents are limited to speech and actions in the 2D digital domain, which cannot be extended to 3D. Since all the actions are in 2D, various visible actions such as making a 3D avatar touch an object in the slide with his/her hand cannot be performed on the fly while the presentation is being played. Also, in these systems, a user cannot edit (e.g., move) the objects within the presentation slide or update the content of the presentation within the same presentation window while the presentation is being played.

### SUMMARY

The present invention relates to a method and system for producing a computerized multi-media presentation. In accordance with the method, one or more meta-slides are defined, each of which is a construct containing a plurality of media events along a time line. A plurality of media actors are selected for inclusion within the meta-slide, wherein each media actor produces a media event along the time line when the media actor is bound to a specified action, and wherein at least one of the media actors is a whiteboard actor. A meta-action is selected from a library containing a plurality of meta-actions, wherein each meta-action specifies the duration and relative timing of a plurality of actions performable by media actors, and wherein the selected meta-action includes a sequence of presentation slides which when are bound to the whiteboard actor produces a discrete slide sequence shown on the whiteboard during the multi-media presentation. The selected meta-action is then bound to the selected media actors in the meta-slide to produce a plurality of media events which occur along the time line synchronized in accordance with the specifications of the meta-action. Media actors such as 3D objects, audio clips, video clips, text, or images may be added to the meta-slide, with selected actions then bound to the added media actors to produce media events. The multi-media presentation may be organized as a plurality of meta-slides.

In one embodiment, the method further includes dynamically editing the multi-media presentation as it is presented by performing actions selected from a group consisting of: 1) deleting, adding, or replacing meta-slides, 2) deleting, adding, or replacing media actors within a meta-slide, and 3) deleting, adding, or replacing meta-actions bound to media actors within a meta-slide. Alternatively, the meta-slide may be edited with a time line-based editor which allows alteration of events and alteration of their temporal sequence along the time line.

In one embodiment, the sequence of presentation slides bound to the whiteboard actor within the meta-slide are imported from a slide presentation program. In another embodiment, the sequence of presentation slides bound to the whiteboard actor within the meta-slide are images downloaded over an internet connection during the multi-media presentation. In another embodiment, the method further includes binding the sequence of presentation slides to the whiteboard actor in the form of a predefined presentation template which includes a virtual reality environment for the whiteboard. In another embodiment, the selected media actors includes a plurality of whiteboards and wherein the meta-action includes a plurality of presentation slide sequences to thereby produce a plurality of slide sequences which occur in parallel along the time line.

In another embodiment, one of the selected media actors is a 3D object which is associated with a scene graph to define an active scene. An active scene may be an augmentation of a virtual reality scene graph specification. The virtual reality scene graph specification may be, for example, VRML (Virtual Reality Modeling Language), X3D, MPEG-4, BIFS (Binary Format for Scenes), or Open Inventor. The 3D actor may selected from a group consisting of a character and an avatar, wherein the 3D actor is overlaid on the time line in order to interact with the presentation slide sequence in a manner specified by the selected meta-action. The 3D actor may be an avatar whose actions include body actions performed by updating body animation parameters (BAP) consistent with MPEG-4 BAP specifications and/or include facial movements and expressions performed by updating facial animation parameters (FAP) consistent with MPEG-4 FAP/FDP (Facial Definition Parameter) specifications. Each such 3D actor may an instance of a class stored in an actor library, wherein the class defines the actions of the 3D actor. The actor library may include a hierarchical action library made up of action templates which enable specific actions to be assigned to an instance of a 3D actor.

The multi-media presentation may be output in a number of different ways. In one embodiment, the presentation is streamed over an internet connection and rendered with a web browser.

### BRIEF DESCRIPTION OF THE DRAWINGS

FIG. 1 shows the 3D meta-slide concept;

FIG. 2 shows a flow chart for meta-slide creation and editing;

FIG. 3 shows a flow chart for playing of a meta-slide; and

FIG. 4 illustrates actions bound to 3D meta-actors shown on a time line as events for 3D meta-slide i.

### DETAILED DESCRIPTION

The present invention is a method and system for the generation of meta-slide based 3D, Virtual Reality, and multi-media content for standalone or interactive showing, presentation, explanation, demonstration, and documentation for use over high and low bandwidth devices. Meta-slides represent a presentation organizing principle suitable for a 3D virtual reality and a 2D multimedia (i.e. video, audio, text and pictures) environment. In contrast to the current art of linearly stringing together 2D multimedia slides for a slide show presentation, the present method and system exploits capabilities of a 3D environment. A meta-slide describes an organizing principle through which the user can interact and dynamically update the content of the presentation during the 3D meta-slide show in the same browser window. The overlaying of 3D virtual reality objects including 3D actors and multiple synchronized 3D actors called 3D meta-actors over multiple slides in a 3D meta-slide results in a continuation of action sequences over multiple slides in a meta-slide. This results in a generalized slide organization procedure not possible by a linear sequencing of slides, which is the current art.

Using the present method and system, one can rapidly create presentations and documents involving virtual avatars, projection screens and other objects for dissemination of content over the internet, including streaming content. This represents a new and a much more efficient way of designing presentations, provides a more visually appealing and a low bandwidth way of explaining concepts using 3D and virtual reality. The features of the software embodiment or system include pre-built models/libraries of actors, actions, motions, scenes, and objects; which are loaded into the scene by the user as needed by clicking mouse buttons, editing including time line based editing and responding to other standard graphical user interface (GUI) requests. In one embodiment, one can take static presentation slides and convert them into 3D interactive slide presentations by merely clicking a few mouse buttons on a computer display monitor. Moreover, by clicking mouse buttons one can interactively alter the content of the presentation while the presentation is being played.

The avatars from actor library can be assigned a particular motion or it can perform motions from a combination of a set of motions in a motion library. The motion library contains prerecorded motions as well as functional representations of commonly performed motions. The avatar can also simulate the facial movements while speaking using a pre-existing audio or text-to-speech (TTS) system. The TTS can be provided by computer operating system or a third party, such as IBM TTS library.

Textures of various types are mapped to the objects in the scene. These textures are based on image files or video files being displayed on the computer screen. The system arranges the actions of the avatar and the objects on a time line and the user is able to manipulate performance of sequences of actions on a time line. A new time line-based easy to use end user editing of sequential events is created on top of and/or as an alternative to frame based editing. Dynamic editing of the presentation while it is being played is possible in our method and system. In addition to the editor mode, the system can operate in a player mode or it can generate a video, which can be streamed over the internet, if needed. For example, the system can generate output in the form of an interactive 3D virtual reality help/manual.

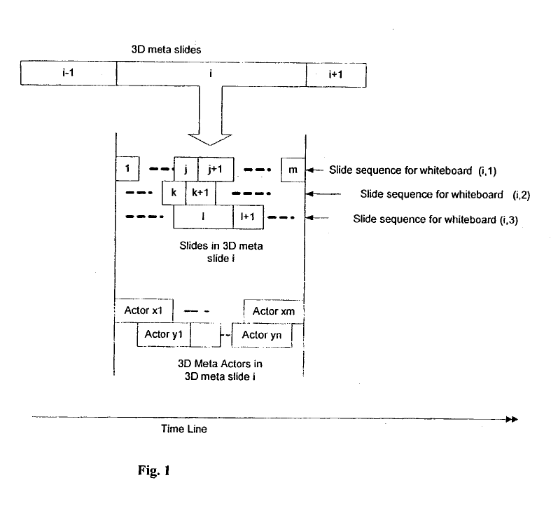

The meta-slide concept is illustrated in FIG. 1. Because the meta-slide technique has particular applicability to the inclusion of 3D actors to a multimedia presentation, meta-slides are sometimes referred to herein as 3D meta-slides whether or not the meta-slide actually contains a 3D actor. The 3D meta-slides i−1, i and i+1 are shown on a time line in a linear sequence. The contents of meta-slide i are shown in-more details. In this example, the 3D meta-slide i is made up of three whiteboards numbered (i,1), (i,2) and (i,3)—the first index referring to the meta-slide number and the second index referring to the whiteboard number. Each of these whiteboards have slides attached to them and the slides are shown in sequence. As can be seen from the illustration, the slides on different whiteboards can be shown simultaneously since they overlap on the time line. The slides also have variable durations, some slides are longer in duration while others are shorter, e.g. slide 1 in the sequence for whiteboard (i,3) has a much longer duration than slide 1+1. The slides on each whiteboard can begin and end at different periods on the time line, e.g. the slide show on whiteboard (i,1) can begin before the slide show on whiteboard (i,2). However all the slide shows on all the whiteboards which are part of 3D meta-slide i have to begin at or after the beginning of 3D meta-slide i and have to end at or before the ending of 3D meta-slide i on the time line.

The 3D meta-actors in 3D meta-slide i are also shown in FIG. 1. As noted in embodiment 3, if the 3D actors are asynchronous then the 3D meta-actors refer to individual 3D actors. On the other hand, if the 3D actors are synchronous then 3D meta-actor refers to a grouping of multiple synchronized actors. The actions of a 3D meta-actor can continue over and span multiple slides. In other words the action sequence need not be terminated at a slide transition, namely at the end of the current slide and the beginning of the next slide. This results in a highly efficient form of presentation without abrupt break of action of the 3D meta-actor.

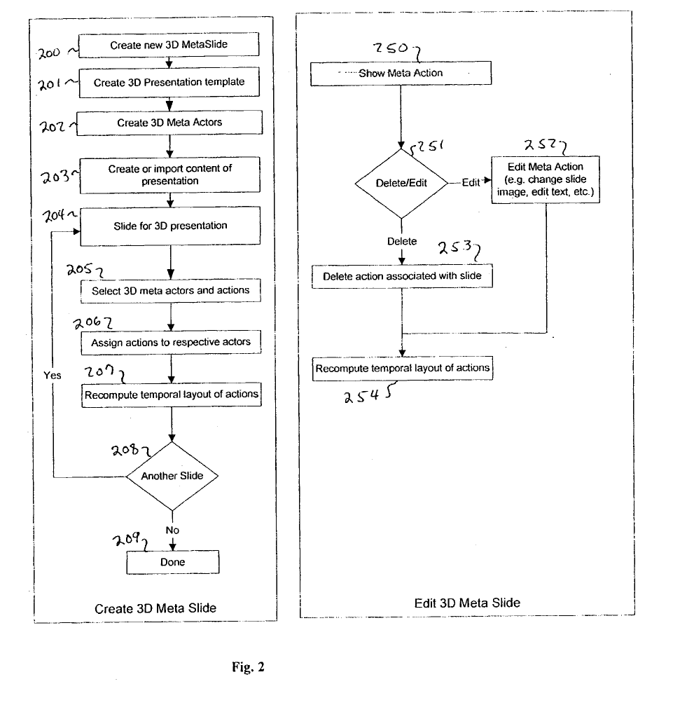

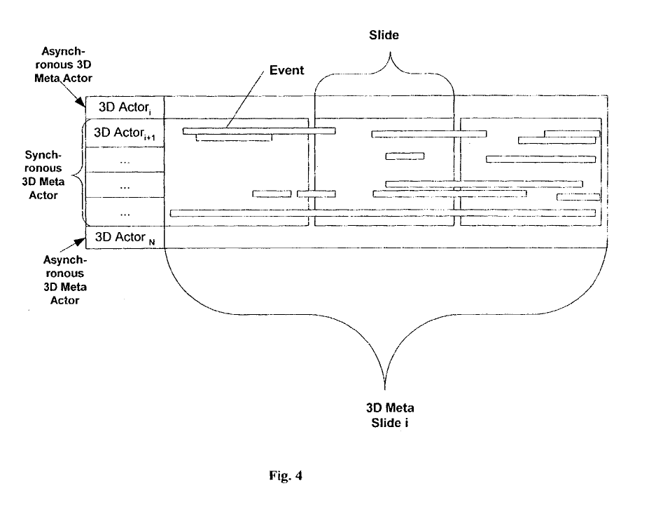

In FIG. 2, the process of creating a new 3D meta-slide is shown in the block on the left as steps 200 through 209. The user clicks a mouse button on the graphical user interface (GUI) and the creation process of the 3D meta-slide is initiated. It prompts the user to create the 3D presentation template, which involves the creation of one or more whiteboards (or slide screens) for 3D presentation slides. The slides are either imported from existing 2D presentation slides or are newly created. A 3D virtual reality environment in which the 3D slides are presented, e.g. a conference room, a staged area, an outdoor area is also loaded as part of the 3D presentation template. Next the 3D meta-actors are created. The presentation content is created or imported next, e.g. Microsoft Powerpoint presentation slides can be imported. The whiteboards, 3D virtual reality environments, 3D meta-actors are most frequently created by selecting from existing pre-built libraries for common situations, however in specialized situations they can also be assembled to meet specific uncommon requirements. After the content of the presentation in the form of slides is created, then each individual slide is processed by first selecting 3D meta-actors such as whiteboards, 3D avatars, 3D characters etc. and synchronously or asynchronously binding their actions such as show slide, point to screen, invoke text to speech (TTS) etc. to the selected actors. Here the user selects actions from a library after selecting the actor, and both the actor and the assigned action appears on the time line for editing, if necessary. Next the temporal layout of actions on the time line needs to be updated. There are many levels of the layout, at the topmost level the 3D meta-slides are laid out as shown in FIG. 1. At a more detailed level the 3D actors and 3D meta-actors are laid out along with all the actions bound to them in the form of events as shown later in FIG. 4. The recomputed temporal layout of actions refers to the update of all the events on the time line. The cycle is repeated until all the slides are processed.

The process of editing a 3D meta-slide is shown in the block on the right in FIG. 2 as steps 250 through 254. It is carried out on a time line. The meta-slides are edited based on editing meta-actions. Let us first distinguish actions from meta-actions. Actions are single actions bound to a single actor, and is depicted as one single block on the time line at the lowest level, which is the level of actors as shown later in FIG. 4. Meta-actions, on the other hand, represent a set of actions bound to one or more actors that are executed sequentially or in parallel. Meta-actions characterize the actions that are bound to the 3D meta-actors taking part in the 3D meta-slide. Many times it is more convenient to define meta-actions first and then define 3D meta-actors to bind these meta-actions.

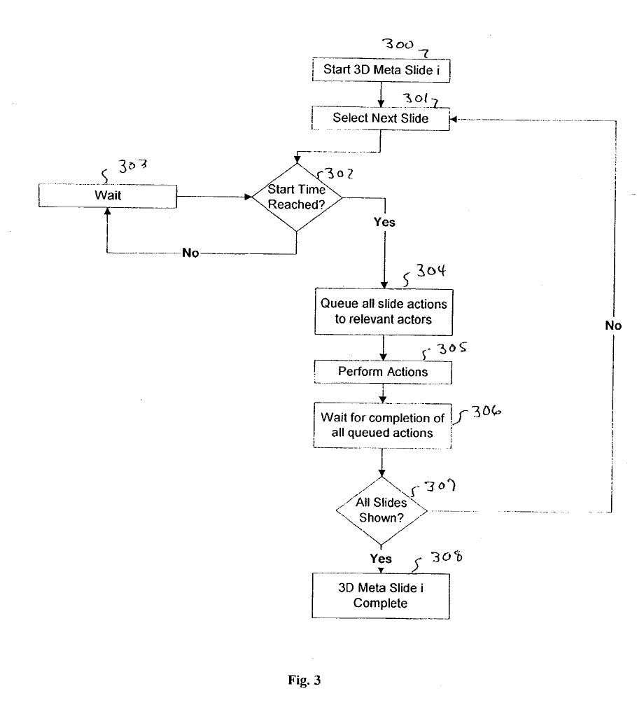

The process of outputting or playing a 3D meta-slide show with meta-slide i is illustrated in FIG. 3 as steps 300 through 308. Once a signal is received to play the 3D meta-slide i by reaching the starting time on the time line shown in FIG. 1, the process begins. The slides constituting the 3D meta-slide as explained in FIG. 2 are sequentially processed. If the start time of each individual slide is reached then they are queued in the action queue of the 3D meta-actor to which the action is already bound as explained in FIG. 2. The queued actions are all performed and the process is repeated for all the slides.

The actions bound to 3D meta-actors are laid out on a time line for ease of editing. The time line based editor is schematically shown in FIG. 4. On the left there is a collection of all the meta-actors vertically arranged in a column taking part in the 3D meta-slide show. The 3D actors may be asynchronous, meaning their actions are independent of other 3D actors. The 3D actors may also be synchronous, in which case the actions of multiple 3D actors are synchronized as a group. One such synchronous 3D meta-actor is shown in FIG. 4, which is made up of 3D actors from i+1 to N−1. When an action is overlayed on a time line for a particular actor, this results in an event. Thus an event is constituted of an action, the beginning and ending time of the action and the actor which performs the action. A number of such events are shown in FIG. 4 while explaining the functioning of the 3D meta-actor. In FIG. 4 we have shown three consecutive slides for meta-slide i, and the events occurring during the slide show involving these three slides. The three slides are shown as three adjacent boxes. As can be seen, some of the events span across multiple slides, which means the actors performing these actions can continue with these actions smoothly across multiple slides without interruption. While FIG. 4 illustrates the concept of a 3D meta-actor with synchronized events for three consecutive slides bound to a whiteboard, the 3D meta-actor events can be synchronized across non-consecutive slides as well as across slides across multiple whiteboards, as explained in FIG. 1.

### 1. EXEMPLARY XML SEGMENT

Listed below is an XML segment of an exemplary 3D meta-slide. There are three actors—whiteboard, presenter and audio. As noted before, actions are single actions bound to a single actor, while meta-actions represent a set of actions bound to one or more actors that are executed sequentially or in parallel. The XML segment explaining the 3D meta-slide is organized through a meta-action. This meta-action can be bound later to 3D meta-actors. This can facilitate automation of the 3D meta-actor creation process. The meta-slide is organized as slides as introduced in FIG. 4, which shows three slides corresponding to 3D meta-slide i. These three slides are elaborated in the following XML segment.

```
<MetaAction>
        <Actors>
        <Actor name=“whiteBoard” representation=“www. . .com/models/screen1.x3d”>
        <Actor name=“Presenter” representation=“www. . .com/models/screen1.x3d”>
        <Actor name=“audio”>
        </Actors>
        <Slide name=“intro”>
          <Actor use=“Presenter”>
        <Event action=“walkto” targetActor=“whiteBoard” startTime=“0:00:00:00”/>
          </Actor>
        </Slide>
        <Slide name=“slide1”>
          <Actor use=“whiteBoard”>
                <Event action=“showSlide” imageURL=“www. . .com/slides/slide1.jpg”
                startTime=“0:00:10:00” duration=“0:00:25:02”/>
          </Actor>
          <Actor use=“Presenter”>
                <Event action=“sayText” text=“Slide 1 of this presentation is now being shown”
                startTime=“0:00:11:00”/>
                <Event action=“leftHandPoint” location=“20.0, 10.0, 20.0” startTime=“0:00:15:06”/>
          </Actor>
        </Slide>
        <Slide name=“slide2”>
          <Actor use=“whiteBoard”>
                <Event action=“showSlide” imageURL=“www. . .com/slides/slide2.jpg”
                startTime=“0:00:30:00” duration=“0:00:25:02”/>
          </Actor>
          <Actor use=“Presenter”>
                  <Event action=“sayText” text=“Slide 2 of this presentation is now being shown”
                startTime=“0:00:32:00”/>
                <Event action=“playMotion” motionURL=“www. .
                .com/motions/presentationMotion.bvh” startTime=“0:00:36:0”/>
                <Event action=“walkTo” location=“0.0, 0.0, 34.0”/>
          </Actor>
        </Slide>
        <Slide>
          <Actor use=“audio”>
                <Event action=“playWav” waveURL=“www. . .com/auto/backgroundMusic.wav”
                startTime=“0:00:00:00”/>
          </Actor>
        </Slide>
</MetaAction>
```

The first slide is named “intro” and it involves the “presenter” actor performing a “walk to” event action to the target “whiteBoard”. Whenever an action is bound to an actor, it can be referred to as an event action (or simply event) as illustrated in FIGS. 4 and 5. The event begins at time 0 and the duration is not specified which by default means that the default duration of the event becomes the duration.

The second slide is named “slide 1”. Here the “whiteBoard” actor is involved in the “showSlide” event from an imageURL, from which slide1.jpg image is loaded. The startTime and duration fields are self explanatory. The “presenter” actor is synchronized with the “whiteboard” actor. In this case the 3D meta-actor involves a grouping of “presenter” and “whiteboard” actors. The “presenter” actor performs two partially parallel events “sayText” and “leftHandPoint”.

Next is “slide 2”. It has some similarity with slide 1. The 3D meta-slide is formed of a group involving “presenter” and “whiteboard” actors. The whiteboard loads slide2jpg image, and the presenter performs “sayText”, “playMotion” and “walkTo” events, which are partially parallel, meaning they are simultaneously performed on a time line. The motion sequence is loaded in Biovision's .bvh format from a URL, as shown.

Finally, the “audio” actor illustrates a continuation action over multiple slides in the 3D meta-slide. An audio clip in .wav file format is played as background music.

### 2. EXEMPLARY EMBODIMENTS

Listed below are a number of specific method and system embodiments employing the techniques described above.

### EMBODIMENT NO. 1

This embodiment relates to a method for generating a plurality of 3-dimensional (3D) meta-slides and scenes (henceforth called 3D meta-slide) is described wherein each 3D meta-slide includes:

a. 3D meta-actors, wherein each 3D meta-actor represents a group of 3D actors

b. 3D avatars (digital humans) and characters, wherein 3D avatars and characters can be grouped

c. 3D and 2-dimensional (2D) presentation slides

d. 3D virtual reality objects

e. traditional multimedia objects such as text, images, audio and video, which may exist locally or may be streamed

f. 3D presentation templates

g. the 3D meta-actors in embodiment la overlayed on a time line with the 3D meta-slide contents in embodiments 1a-f.

### EMBODIMENT NO. 2

This embodiment relates to a method for augmenting the following to 3D actors in embodiment 1a:

a. 3D virtual reality objects in embodiment 1d

b. multimedia objects in embodiment 1e

c. 3D and 2D presentation slides

### EMBODIMENT NO. 3

This embodiment relates to a method for specializing 3D actors in embodiment 1a to:

a. 3D avatars and characters in embodiment 1b

b. 3D presentation template in embodiment 1f

### EMBODIMENT NO. 4

This embodiment relates to a method for binding actions to 3D meta-actors through an action template. The actions designed by the action template can be selectively bound to the designated 3D and traditional media objects such as audio, image and video.

a. The 3D actors may be asynchronous, meaning their actions are independent of other 3D actors. In such a case a 3D meta-actor is the same as a 3D actor

b. The 3D actors may be synchronous, in which case the actions of multiple 3D actors are synchronized. Such synchronous 3D actors are grouped as a 3D meta-actor.

### EMBODIMENT NO. 5

This embodiment relates to a method for generating 3D presentation templates. A 3D presentation template includes:

a. One or more whiteboards (or slide screens) for 3D presentation slides. The slides are either imported from existing 2D presentation slides or are newly created.

b. 3D virtual reality environment in which the 3D slides are presented, e.g. a conference room, a staged area, outdoor presentation.

The 3D presentation slides may include one slide or multiple slides in a linear sequence, and are bound to a whiteboard. Multiple linear sequences of slides can be simultaneously presented in the 3D presentation template, by using multiple whiteboards and by binding each sequence to each whiteboard.

### EMBODIMENT NO. 6

This embodiment relates to a method for overlay of 3D meta-actors on a time line with the 3D meta-slide contents in embodiments 1a-f. Depending on the overlay logic, one or more synchronous or asynchronous 3D presentations are coordinated by a 3D meta-actor.

### EMBODIMENT NO. 7

In this embodiment, a 3D meta-slide represents an organizing principle through which the user can interact and dynamically update the content of the presentation during the 3D meta-slide playback.

### EMBODIMENT NO. 8

In this embodiment, the import of existing 2D slides or creation of new slides in embodiment 5a is achieved either by

a. a texture map of an image of each existing 2D slide using a standard format such as JPEG (Joint Photographic Experts Group), TIFF (Tag Image File Format ) on a 3D flat box representing a whiteboard, or

b. XML (eXtensible Markup Language) or X3D (eXtensible 3D) tag representation of multimedia contents of slides, including text, pictures, video clips, sound clips and other objects such as drawings using existing standard multimedia formats for each component (text (e.g. html, rtf), picture (e.g. jpg, tif,), video (e.g. mpeg, mov), sound (e.g. wav, mp3) etc.).

### EMBODIMENT NO. 9

In this embodiment, a system for generating 3D virtual reality objects incorporating methods such as embodiments 2 through 5 includes generating the geometry, transformation, texture mapping, animations, behaviors, sensors and other features consistent with a standard virtual reality scene graph specification such as VRML (Virtual Reality Modeling Language), X3D, Moving Pictures Experts Group—MPEG-4 BIFS (Binary Format for Scenes) or Open Inventor. The system may also augmenting 3D virtual reality objects to 3D actors in accordance with method embodiment 3. The standard 3D scene graph is augmented to an active 3D scene graph in the system by inclusion of 3D meta-actors to selectively benefit from the special action template representation and editing features.

### EMBODIMENT NO. 10

In this embodiment, for a 3D avatar or a 3D character in embodiment 1b, the specialized actions include:

a. body actions by updating body animation parameters (BAP) consistent with MPEG-4 BAP specifications;

b. facial movements and expressions by updating facial animation parameters (FAP) consistent with MPEG-4 FAP/FDP (Facial Definition Paremeter) specifications. Both TTS (Text To Speech) and voice recording inputs in popular formats (such as wav, mp3) are included.

### EMBODIMENT NO. 11

In this embodiment, if an overlay in embodiment 5 occurs over multiple slides in a 3D meta-slide, then it results in a continuation of action sequences over multiple slides in the 3D meta-slide.

### EMBODIMENT NO. 12

In this embodiment, the 3D meta-slides are linearly organized on a time line and can be edited at three levels:

a. First, the 3D meta-slide organization can be edited on a time line. This results in cutting, pasting, reorganization of meta-slide sequence, forwarding, reversing and other features related to the linear sequencing of 3D meta-slides, and related editing

b. Second, each meta-slide can be edited, which exposes one or more linear sequences of 3D slides constituting a 3D meta-slide. Each slide forming the 3D meta-slide can now be edited.

c. Third, there are multiple parallel tracks on a time line to enable individual editing of each 3D actor within a 3D meta-slide. With this option one can not only edit the content of each slide in the meta-slide but also the 3D actor overlay on the slide sequence.

### EMBODIMENT NO. 13

In this embodiment, the editing is applied to create new 3D meta-slides or to edit existing ones. The playing of 3D meta-slides on a time line results in a 3D slide show. The system can be used as a 3D meta-slide editor and as a 3D meta-slide player. The player mode can be used locally or it can be used within an internet browser, where content can be streamed selectively. The 3D content can be transmitted across high bandwidth as well as low bandwidth connections based on MPEG-4 or other such specifications.

### 3. DETAILED DESCRIPTIONS OF METHOD EMBODIMENTS

Embodiment 2 addresses a method for augmenting 3D virtual reality objects to 3D actors. 3D actors make it possible to unify simple behaviors commonly associated with 3D virtual reality objects such as keyframe interpolation, touch sensor, time sensor with more complex behaviors such as facial and body gestures of 3D avatars under a unified action template. The actions designed by the action template can be bound to the designated 3D actor. Most actions and meta-actions fall into four main categories:

a. Transform: e.g. scale, pulse, rotate, move

b. Material: e.g. change color, flash, transparent, opaque

c. Human and character actors: e.g. walk, point, grasp

d. Specialized or Context Specific: e.g. slide show, presentation content, driving

An actor can manifest in many forms such as a human, animal, a real or artificial character, or an inanimate object such as a machine or a robot. Most actors are 3D actors, some are not—in fact some are not even visual actors, such as audio. The common actor framework, however, can address both 3D actors as well as non-3D multimedia actors.

A 3D actor operates in a 3D scene, referred to herein as an active scene because it provides enhanced behavioral editing capabilities. An active scene is an augmentation of a standard virtual reality scene graph format such as VRML, X3D, MPEG-4 BIFS, and Open Inventor. The actors are stored hierarchically in a database, which constitutes an actor library. The actor classes are stored in this library. An actor class lists the actions that can be performed on it and what state changes they cause. Among other fields, a list of grasp or contact sites (such as knobs, buttons) and directions (such as movement directions) are predefined with respect to the actors. These fields help orient actions that involve objects, such as grasping, reaching, and locomotion. When an actor is selected from this library, an instance of it is created. A collection of such actor instances are then associated with a scene graph, to create an active scene.

The 3D actors execute actions. The rationale for an active scene by the introduction of actors is that one can then automate the time consuming steps in VR content creation by allowing the actors to execute many of the low level repetitive details. Let us provide a simple example to explain the concept. In current VR and web3D modeling (i.e. content building) tools such as 3DSMax, Alias/Maya and Softimage if one were to design actions of an actor, then one has to specify the location coordinates of the point in space where the target is located in the environment, specify how to take the actor to the target, how to locate the actor component in order to interact with the target. Whereas in our method and system all the above actions are preprogrammed because both the actor and the presentation template are picked as actors from actor library so the user can concentrate on the actual actions, not how and where to move actor components. In essence, using current art to develop an application will require every animation frame-by-frame using certain key frames and interpolating between two consecutive key frames. There are three common types of key frames: translate (linear), rotate (circular) and scale (e.g. squeeze and stretch along some pivot point of object to model situations such as heart beats etc.). Using our method and system, the content can be built action-by-action. The animation content created using frame-by-frame can also be created or imported into our system, if needed. As a result our preferred embodiment results in significant increase in efficiency.

The action library is organized hierarchically. The top level behaviors represent compound actions, which are constructed by syntactically combining the next lower level, which represent elementary or unit actions. Examples of behavior can be a human walking up to a whiteboard object or advancing the slide object in a presentation process, whereas examples of unit action can be move to or fade or twist for objects, and walk or sit or grasp for humans. Finally at the lowest level of the action library one has some of the technological components used in constructing the actions, such as facial animation technology, inverse kinematics (IK) technology, motion capture technology and computational algorithmic technology. The lowest level can be used to extend actions in the library or to address a unique (i.e. one of a kind) situation which cannot be effectively addressed by a unit action.

The action library is built using an action template. The action template consists of default fields such as action units (units, numbers, once only or periodic etc.); the period and target of applicability; start and end time and state; the participant actors and objects; the path of action, namely direction, start, end and distance; the purpose of action, namely what is achieved, what is generated and what is enabled; the sub action, parent action, previous action, concurrent action and next action; and any other links to other objects.

The 3D actors may be asynchronous, meaning their actions are independent of other 3D actors. In such a case a 3D meta-actor is the same as a 3D actor. The 3D actors may be synchronous, in which case the actions of multiple 3D actors are synchronized. Such synchronous 3D actors are grouped as a 3D meta-actor. An example of synchronized actors is a specific body or facial gesture of a 3D avatar (first 3D actor) for a particular 3D object instantiated as a 3D actor (second 3D actor) in a 3D slide (third 3D actor). Actions may be bound to 3D meta-actors using the action template. The actions of the involved 3D actors can be laid out and edited through the events on the time line as shown in FIG. 4.

A 3D presentation template may also be employed which consists of one or more whiteboards (or slide screens) for 3D presentation slides. The 3D presentation slides are bound to a whiteboard. 3D slides consist of one slide or multiple slides in a linear sequence. Multiple linear sequences of slides can be simultaneously presented in the 3D presentation template, using multiple whiteboards as illustrated in FIG. 1. The slides are either imported from existing 2D presentation slides or are newly created. The 3D presentation template may also consist of a 3D virtual reality environment in which the 3D slides are presented, e.g. a conference room, a staged area, or an outdoor environment.

Events are used to link multiple processes in the presentation such as a hypertext markup language (html) window, a 3D window, and other elements of a graphical user interface. Through an html window one can embed text, spreadsheets, diagrams, pictures, figures, formulas, equations, and other elements as actors, if needed. Through a 3D window one can embed the 3D elements of the presentation. Through other elements of a graphical user interface one can embed standard widgets as actors if needed, such as help menus, organization of content in chapters/sections etc. All these actors can generate events as indicated in FIG. 4.

For a 3D avatar or a 3D character in Embodiment 10, the specialized actions involve two major parts: (i) body actions by updating body animation parameters consistent with h-anim/MPEG-4 BAP specifications, and (ii) facial movements and expressions by updating facial animation parameters consistent with MPEG-4 FAP/FDP specifications. Both TTS and voice recording inputs in popular formats (such as wav, mp3) are included.

The lowest level of the action library has the technological components used in constructing the actions. The lowest level can be used to extend actions in the library or to address a unique (i.e. one of a kind) situation which cannot be effectively addressed by a unit action. The raw motions which cannot be uniquely associated with an action is stored as part of a motion library. These motions are generated from one or more of the following technologies: inverse kinematics (IK) technology, motion capture technology, collision detection, and computational algorithmic technology.

The avatar motions are stored according to the body animation parameter (BAP) specifications in MPEG-4 specifications [Walsh and Bourges-Sevenier, 2002] or an alternative format such as biovision or acclaim file format. Full body motions including hand, feet and fingers are stored.

The motion generator operates on low level actions, which come from four main sources: (i) inverse kinematics (IK), (ii) motion capture and subsequent post processing, (iii) facial animation or (iv) computed motions. For the most part, the motion picking process is embedded within the actions. For motions which cannot be expressed or captured by actions, the motion picking is either done by the user or is done through some scripts written according to some logic for motion picking Binding motions to actors is conceptually similar to the process of binding actions to actors. Motion editing capabilities are used, e.g. motion blending, motion retargeting etc. By motion blending we refer to functional algorithms to smoothly connect motion segments, by motion retargeting we refer to applying motion segments to various actors.

Finally embodiment 1 addresses a method for generating a plurality of 3D meta-slides and scenes (henceforth called 3D meta-slide) is described wherein each 3D meta-slide includes:

a. 3D meta-actors, wherein each 3D meta-actor represents a group of 3D actors

b. 3D avatars (digital humans) and characters, wherein 3D avatars and characters can be grouped

c. 3D and 2D presentation slides

d. 3D virtual reality objects

e. traditional multimedia objects such as text, images, audio and video, which may exist locally or may be streamed

f. 3D presentation templates

g. the 3D meta-actors in embodiment 1a overlayed on a time line with the 3D meta-slide contents in embodiments 1a-f. Depending on the overlay logic, one or more synchronous or asynchronous 3D presentations are coordinated by a 3D meta-actor.

As introduced in FIG. 4, meta-slide editing provides a form of high-level end-user programming of sequential events, without having to perform actual computer programming.

The time line is constructed by noting that the actions also have certain preparatory specifications. These are a list of <CONDITION, action> statements. The conditions are evaluated first and have to be satisfied before the current action can proceed. It may be a single action or a complex combination of actions.

If an overlay occurs over multiple slides in a 3D meta-slide then it results in a continuation of action sequences over multiple slides in the 3D meta-slide. Here the action sequences need not be abruptly terminated every time there is a transition from one slide to the next.

### 4. DETAILED DESCRIPTIONS OF SYSTEM EMBODIMENTS

A particular system embodiment for the above methods will now be described which makes use of a number of existing standards. A system for generating 3D virtual reality objects incorporating methods such as described above may include means for generating the geometry, transformation, texture mapping, animations, behaviors, sensors and other features consistent with a standard virtual reality scene graph specification such as VRML, X3D, MPEG-4 BIFS or Open Inventor.

Whereas generic 3D virtual reality objects can be addressed by the system in embodiment 9, a more specialized 3D virtual reality object representation is generated for embodiment of 3D actors in embodiment 3. Examples of 3D actors in our system are 3D avatar or 3D character including human characters. Any 3D virtual reality object can be instantiated as 3D actors to benefit from the special action template representation and editing features.

A 3D presentation template consists of one or more whiteboards. E.g. by double clicking on a template icon—a number of options associated with the presentation are activated. The 3D presentation slides are bound to a whiteboard.

The time line editor synchronizes the talking avatar with the content of the presentation or the user manual. The MPEG compliant avatar is lip synchronized with the input voice stream, which is generated either by pre-recording or through text.

The 3D meta-slide system represents an organizing principle through which the user can interact and dynamically update the content of the presentation during the 3D meta-slide show in the same browser window. The 3D meta-slides are linearly organized on a time line and can be edited. There are three main types of editing:

a. The 3D meta-slide organization can be edited on a time line. This results in cutting, pasting, reorganization of meta-slide sequence, forwarding, reversing and other features related to the linear sequencing of 3D meta-slides.

b. Each meta-slide can be edited, which exposes one or more linear sequences of 3D slides constituting a 3D meta-slide. Each slide forming the 3D meta-slide can now be edited.

c. Furthermore there are multiple parallel tracks on a time line to enable individual editing of each 3D actor within a 3D meta-slide.

With this option on can not only edit the content of each slides in the meta-slide but also the 3D actor overlay on the slide sequence.

The import of existing 2D slides or creation of new slides in embodiment 4a is achieved either by

a. a texture map of an image of each existing 2D slide using a standard format such as JPEG, TIFF on a 3D flat box representing a whiteboard, or

b. XML or X3D tag representation of multimedia contents of slides, including text, pictures, video clips, sound clips and other objects such as drawings using existing standard multimedia formats for each component (text (e.g. html, rtf), picture (e.g. jpg, tif,), video (e.g. mpeg, mov), sound (e.g. wav, mp3) etc.).

The content is first input into our system and stored. The content and narrative can either be a multimedia segment consisting of video, audio, text or pictures or a VR segment consisting of a scene graph with objects and the environment, as well as scripts. The logic of the content and narrative is stored either as XML templates if it is in a predefined format, or is handled by the user.

The editing can be applied to create new 3D meta-slides or to edit existing ones. Selecting slideshow enables loading of slides from a file and caching it into the memory.

Finally, the playing of 3D meta-slides on a time line results in a 3D slide show. The playback allows for showing one meta-slide at a time, or showing all of them in a continuous sequence. The playback of one meta-slide at a time may be controlled by a text based menu. The player mode can be used locally or it can be used within an internet browser, including streaming content.

The 3D presentation or documentation is constructed as a result of a sequential combination of events accomplished by the time block based editing of content explained above. Normally this is the place where the user edits the overall content by appropriate movement of the camera actor, appropriate combination of various multimedia and scene components, and based on the input slide or manual content and/or narrative.

The features of the software embodiment or system include pre-built models/libraries of actors, actions, motions, scenes, and objects; which are loaded into the scene by the user as needed by clicking mouse buttons, editing including time line based editing and responding to other standard graphical user interface (GUI) requests.

The avatars from actor library can be assigned a particular motion or it can perform motions from a combination of a set of motions in a motion library. The motion library contains prerecorded motions as well as functional representations of commonly performed motions. The avatar can also simulate the facial movements while speaking using a pre-existing audio or TTS system. The TTS can be provided by computer operating system or a third party, such as IBM TTS library.

Textures of various types are mapped to the objects in the scene. These textures are based on image files or video files being displayed on the computer screen. The system arranges the actions of the avatar and the objects on a time line and the user is able to manipulate performance of sequences of actions on a time line. A new time line-based easy to use end user editing of sequential events is created on top of and/or as an alternative to frame based editing. Dynamic editing of the presentation while it is being played is possible in our method and system. The content of the system are viewed in a player (with navigational capabilities) or as a static or dynamically generated video, all of which of which can be streamed over the internet. The state of the presentation consisting of all actions, all actors, all objects, and all scripts are stored and retrieved as needed. The automation in our presentation management system makes the multi-media and VR content creation possible in a significantly reduced time.

Although the invention has been described in conjunction with the foregoing specific embodiments, many alternatives, variations, and modifications will be apparent to those of ordinary skill in the art. Such alternatives, variations, and modifications are intended to fall within the scope of the following appended claims.

What is claimed is:

1. A method for producing a computerized multi-media presentation, comprising:
defining one or more meta-slides, each of which is a construct for containing a plurality of media events along a time line;
selecting a plurality of media actors for inclusion within the meta-slide, wherein each media actor produces a media event along the time line when the media actor is bound to a specified action, and wherein at least one of the media actors is a whiteboard actor;
selecting a meta-action from a library containing a plurality of meta-actions, wherein each meta-action specifies the duration and relative timing of a plurality of actions performable by media actors, and wherein the selected meta-action includes a sequence of presentation slides which when are bound to the whiteboard actor produces a discrete slide sequence shown on the whiteboard during the multi-media presentation; and,
binding the selected meta-action to the selected media actors in the meta-slide to produce a plurality of media events which occur along the time line synchronized in accordance with the specifications of the meta-action.

2. The method of claim 1 further comprising organizing the multi-media presentation as a plurality of meta-slides.

3. The method of claim 2 further comprising dynamically editing the multi-media presentation as it is presented by performing actions selected from a group consisting of: 1) deleting, adding, or replacing meta-slides, 2) deleting, adding, or replacing media actors within a meta-slide, and 3) deleting, adding, or replacing meta-actions bound to media actors within a meta-slide.

4. The method of claim 1 further comprising the editing the meta-slide with a time line-based editor which allows alteration of events and alteration of their temporal sequence along the time line.

5. The method of claim 1 further comprising binding the sequence of presentation slides to the whiteboard actor in the form of a predefined presentation template which includes a virtual reality environment for the whiteboard.

6. The method of claim 1 wherein one of the selected media actors is a 3D object which is associated with a scene graph to define an active scene.

7. The method of claim 6 wherein the 3D actor is selected from a group consisting of a character and an avatar, and wherein the 3D actor is overlaid on the time line in order to interact with the presentation slide sequence in a manner specified by the selected meta-action.

8. The method of claim 7 wherein the 3D actor is an avatar whose actions include body actions performed by updating body animation parameters (BAP) consistent with MPEG-4 BAP specifications.

9. The method of claim 7 wherein the 3D actor is an avatar whose actions include facial movements and expressions performed by updating facial animation parameters (FAP) consistent with MPEG-4 FAP/FDP (Facial Definition Parameter) specifications.

10. The method of claim 7 wherein each 3D actor is an instance of a class stored in an actor library, wherein the class defines the actions of the 3D actor.

11. The method of claim 10 wherein the actor library further comprises a hierarchical action library made up of action templates which enable specific actions to be assigned to an instance of a 3D actor.

12. The method of claim 6 wherein an active scene is an augmentation of a virtual reality scene graph specification.

13. The method of claim 12 wherein the virtual reality scene graph specification is selected from a group consisting of VRML (Virtual Reality Modeling Language), X3D, MPEG-4, BIFS (Binary Format for Scenes), and Open Inventor.

14. The method of claim 1 further comprising adding to the meta-slide one or more media actors selected from a group consisting of audio clips, video clips, text, and images and binding selected actions to the added media actors to produce media events.

15. The method of claim 1 wherein the sequence of presentation slides bound to the whiteboard actor within the meta-slide are imported from a slide presentation program.

16. The method of claim 1 wherein the sequence of presentation slides bound to the whiteboard actor within the meta-slide are images downloaded over an internet connection during the multi-media presentation.

17. The method of claim 1 wherein the selected media actors includes a plurality of whiteboards and wherein the meta-action includes a plurality of presentation slide sequences to thereby produce a plurality of slide sequences which occur in parallel along the time line.

18. The method of claim 1 further comprising streaming the multi-media presentation over an internet connection and rendering the presentation with a web browser.
